(19) United States
(12) Patent Application Publication
(10) Pub. No.: US 2013/0061427 A1
(43) Pub. Date: Mar. 14, 2013

(54) HINGE AND METHOD OF ADJUSTMENT

(71) Applicants: Craig Lang, Thomastown (AU); Anthony Fisicaro, Thomastown (AU)

(72) Inventors: Craig Lang, Thomastown (AU); Anthony Fisicaro, Thomastown (AU)

(73) Assignee: MAMMOTH INDUSTRIES PTY LTD, Thomastown, VIC (AU)

(21) Appl. No.: 13/635,556

(22) PCT Filed: Mar. 18, 2011
(86) PCT No.: PCT/AU2011/000301

§ 371 Date: Nov. 28, 2012

(30) Foreign Application Priority Data
Mar. 18, 2010 (AU) 2010901136

(51) Int. Cl. E05D 7/00; E05D 3/02

(52) U.S. Cl. CPC E05D 7/0027; E05D 3/02
USPC 16/248

(57) ABSTRACT

The present invention relates to the field of hinges and carriage mechanisms adapted to hang a door, window or the like. In one particular aspect the present invention is suitable for use as a means of providing height adjustment for a door. The present invention discloses a hinge having a locking mechanism adapted to be operable in a unlocked position, in which the height of the hinge relative to a proximate structure may be adjusted and a locked position, in which the relative height of the hinge may not be adjusted.

### FIELD OF INVENTION

The present invention relates to the field of hinges and carriage mechanisms.

In one form, the invention relates to a hinge and carriage mechanism adapted to hang a door, gate, panel, window or the like.

In one particular aspect the present invention is suitable for use as a means of providing height adjustment for a door.

It will be convenient to hereinafter describe the invention in relation to its application to a door, however it should be appreciated that the present invention is not limited to that use only.

### BACKGROUND ART

Throughout this specification the use of the word “inventor” in singular form may be taken as reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

In prior art arrangements, a hinge is often used to ‘hang’ a door. In other words, the hinge enables the door to move freely (open or close) by providing a pivot point about which an edge of the door can be rotated relative to a door frame or opening. The positioning of a hinge on the door frame also determines the height of the door, that is the relative spacing between the door fame and the door surface to ensure the door is relatively free to move. In practice, however, a person hanging a door will not get the door position correct; and some adjustment will be needed.

With this in mind, various prior art hinges incorporate mechanisms which enable adjustment of the vertical height of the door relative to the door frame, such as arrangements where the door is hung on the pivot pin. One of these adjustment mechanisms typically uses a small screw which can bias the pivot pin vertically so the door position relative to the hinge is adjusted In the case of the screw adjustment, the screw is often quite small and therefore has been easily lost and has also been found to be difficult to adjust by adult sized hands.

Another adjustment mechanism uses a threaded bolt. In this mechanism, the pivot pin comprises a threaded bolt (which forms a part of the pivot of the hinge) and which enables height adjustment by rotation of the threaded bolt relative to the hinge. However, it has been found that as the door is pivoted on the hinge, the threaded bolt also rotates, thus changing the height of the door as it opens and closes. This is considered undesirable.

### SUMMARY OF INVENTION

It is an object of the embodiments described herein to overcome or alleviate at least one of the above noted drawbacks of related art systems or to at least provide a useful alternative to related art systems.

In a first aspect of embodiments described herein there is provided a hinge comprising a first portion adapted to provide a pivot, a second portion adapted to engage a proximate structure and a locking mechanism adapted to be operable in a unlocked position, in which the relative displacement of the first and/or second portion of the hinge is adjustable relative to the proximate structure, and a locked position, in which the displacement of the first and or second portion is substantially not adjustable relative to the proximate structure.

In another aspect of embodiments described herein there is provided a method of adjusting a hinge, the hinge having first and second portions moveable relative to each other, and a locking mechanism comprising a locking collar adapted to cooperate with a corresponding seat, the method comprising disengaging a locking collar from its corresponding seat and displacing the first part relative to the second part.

Other aspects and preferred forms are disclosed in the specification and/or defined in the appended claims, forming a part of the description of the invention.

In essence, embodiments of the present invention stem from the realization that using a releasable locking mechanism in association with a hinge, the relative height of the hinge can be adjusted to a selected position, and thereafter temporarily set, relative to a proximate structure.

Advantages provided by the present invention comprise the following:
Special tools are not required to enable adjustment
A locking collar may be provided which may enable adjustment by hand
A disposable clip may be provided to keep the locking mechanism temporarily disengaged during installation making adjustment a one handed operation. Once the desired adjustment is set the clip can be removed and discarded, which will then allow the locking mechanism to engage automatically.
The locking mechanism preferably does not lock the adjusting axle to the hinge; allowing the hinge to operate as a true hinge and not pivot on the axle thread.

Further scope of applicability of embodiments of the present invention will become apparent from the detailed description given hereinafter, However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIG. 1 illustrates one embodiment of the present invention, in an unlocked configuration;

FIG. 2 illustrates, in an exploded view an embodiment of the present invention;

FIG. 3 illustrates a sectioned view of FIG. 1;

FIG. 4 illustrates an embodiment of a locking arrangement according to the present invention; and

FIG. 5 illustrates one embodiment of the present invention, in a locked configuration.

### DETAILED DESCRIPTION

The present invention relates to an adjustable pivot mount for a panel, typically a panel of a door, folding door and/or window or similar closure. The present invention is applicable to top, bottom and/or intermediate mounts for a panel. It is also important to note that the present invention may be used for adjustment of the height of a panel, and/or adjustment of the lateral position of a panel. Embodiments described below relate primarily to height adjustment, but the present invention should not be construed as being so limited.

FIG. 1 shows one embodiment of the present invention. The hinge 100 as shown is adapted to be coupled to a proximate structure, such as a roller mechanism 101 suitable for tracks, however, the present invention is applicable to any form of hinge whether or not they have ancillary mechanisms or are coupled to proximate structures adapted for specific applications.

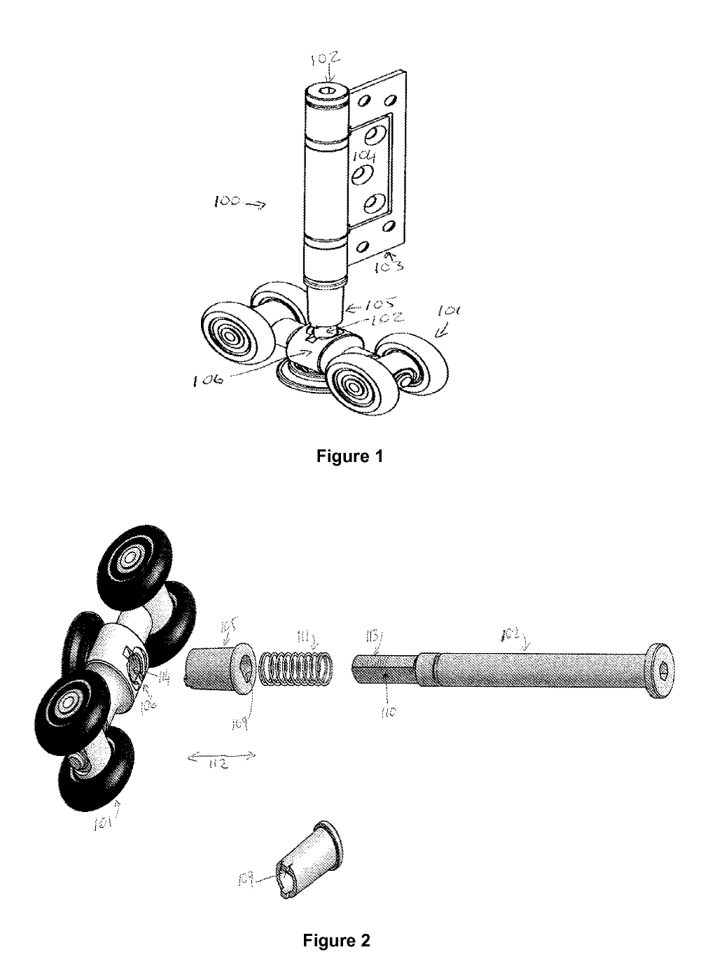

The hinge 100 has a support pin 102 (shown in FIG. 2) about which flag 103 and flag 104 of the hinge can pivot. In some uses of the present invention, the support pin is used as a pivot and in other uses the support pin is not used as a pivot. Both uses are contemplated within the scope of the present invention. There is also a locking collar 105 which is adapted to releasably engage a proximate structure, such as a corresponding locking seat 106 in a locked position. The locking collar 105 is also adapted to engage the support pin 102, and will be better described with reference to FIG. 2. The locking seat 105 may form a part of the hinge mechanism (as illustrated), or may form a part of a door frame or other proximate structure 106, without limiting the scope of the present invention. The locking collar 105 and locking seat 106 may also be configured in a kinematic inversion, for example where the seat 106 is provided with the support pin 102 and the locking collar 105 is provided with the proximate structure.

FIG. 2 illustrates, in an exploded view an embodiment of the present invention and the interaction of the support pin 102 and locking collar 105. The pivot 102 and locking collar 105 preferably engage each other in a manner which substantially avoids rotation. For example, in the embodiment illustrated, the support pin 102 and collar 105 have a respective flat surface 109, 110 which provides a mechanical coupling substantially avoiding rotation. Other suitable means of interaction between collar 105 and pin 102 are contemplated, such as respective key and slot (not shown). The manner of interaction between the collar 105 and pin 102 is not considered important, other than to substantially avoid or limit rotation between the collar 105 and pin 102. The locking collar may be associated with a biasing means, such as a spring 111 or other suitable means to bias the collar to a ‘locked’ position, as illustrated in FIG. 2.

In order to adjust the relative displacement of the hinge pin 102 relative to the proximate structure 101, in the embodiment illustrated, the locking collar 105 may be moved axially 112, by way of illustration, so the collar disengages the seat 106. The support pin 102 may then by rotated (preferably together with the collar 105) and displaced by action of the thread 113, 114 on the support pin 102 and seat 106 respectively. Other suitable ways of adjusting the relative displacement of the support pin and the seat (although not illustrated) are contemplated within the scope of the present invention, but the manner of displacement as provided in a particular embodiment is not considered essential to the present invention.

FIG. 2 illustrates one embodiment of the locking collar 105 and corresponding locking seat 106. The locking collar 105 and seat 106 have corresponding teeth 107, although any suitable complimentary means may be used to provide the relative locking capability required in accordance with the present invention.

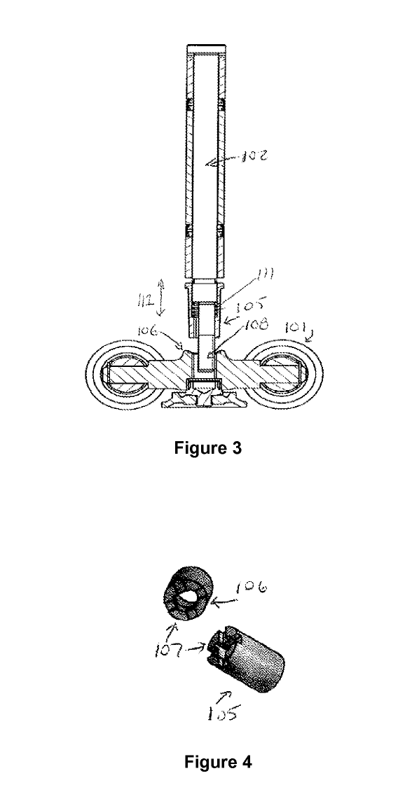

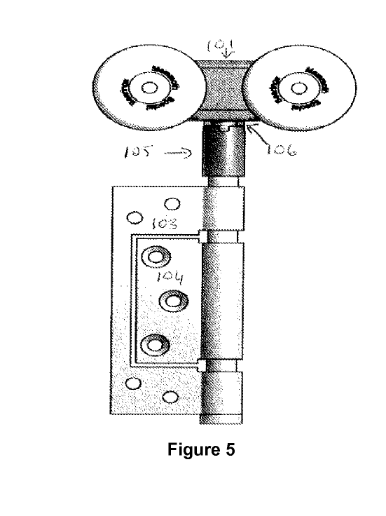

FIG. 3 provides further illustration of the working of an embodiment of the present invention. The collar 105 is disengaged from the seat 106, for example by axial displacement 112 of the collar 105 away from the seat 106. In this position, the spring 111 is compressed and the support pin 102 (which engages 108 the proximate structure having a carriage mechanism 101 by thread or any other suitable manner, for example as illustrated in FIG. 2) may be rotated relative to the carriage mechanism 101, thus adjusting the displacement of support pin 102 (and according the hinge vertical displacement in use) relative to the proximate structure 101. After adjustment of the support pin 102, the locking collar 105 may once again engage the seat 106 as illustrated in FIG. 5. The spring 111 acts to bias the collar 105 toward the seat 106.

FIG. 4 illustrates an alternative embodiment of the collar 105, seat 106 with multiple teeth 107 serving to provide a releasable locking function between the collar 105 and seat 106. Within the scope of the present invention, the particular embodiment of locking between the collar and the seat 106 is not essential to the present invention.

In FIG. 5, the collar 105 is shown engaged with seat 106. In this configuration, as illustrated also with reference to FIG. 2, the support pin 102 engages the locking collar 105 (for example by way of surfaces 109 and 110) and, in turn, the locking collar 105 engages the proximate structure 101 for example via seat 106 thus substantially preventing movement (and thus displacement) of the support pin relative to the proximate structure 101. The hinge flags 103 and 104 are adapted to rotate around the support pin 102, relative to the structure 101.

In an alternative embodiment (not shown), the support pin 102 may be displaced relative to the locking collar 105 or seat 106. In other words, the support pin 102 may engage the collar 105 or seat 106, rather than the carriage mechanism 101, and thus adjustment, in a unlocked position, may be made relative the point of engagement between the support pin 102 and the (or one of the) portion(s) of the hinge with which the support pin 102 is engaged.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

1. A hinge comprising
a first portion adapted to provide a pivot,
a second portion adapted to engage a proximate structure
a locking mechanism adapted to be operable in an unlocked position, in which the relative displacement of the first and/or second portion of the hinge is adjustable relative to the proximate structure, and a locked position, in which the displacement of the first and or second portion is substantially not adjustable relative to the proximate structure.

2. A hinge as claimed in claim 1, wherein the first portion is a support pin.

3. A hinge as claimed in claim 2 wherein the support pin is used as a pivot.

4. A hinge as claimed in claim 1, wherein the second portion comprises the locking mechanism.

5. A hinge as claimed in claim 1, wherein the locking mechanism comprises a locking collar and a corresponding seat.

6. A hinge as claimed in claim 1, wherein the first and second portions are adapted to engage to substantially avoid rotation relative to each other.

7. A hinge as claimed in claim 1, wherein the first and/or the second portions are adapted to rotate relative to the proximate structure in an unlocked position.

8. A hinge as claimed in claim 1, wherein the displacement is axial displacement relative to the first portion.

9. A hinge as claimed in claim 1, wherein the displacement is lateral displacement relative to the proximate structure.

10. In combination, a panel comprising a frame adapted to have a hinge fitted thereto, and a hinge as claimed in claim 1.

11. A method of adjusting a hinge, the hinge having first and second portions moveable relative to each other, and a locking mechanism comprising a locking collar adapted to cooperate with a corresponding seat, the method comprising the steps of:
disengaging a locking collar from its corresponding seat and displacing the first part relative to the second part.

12. A method as claimed in claim 10, further comprising the step of reengaging the locking mechanism after displacing the first part.

13.-14. (canceled)
